(19) United States
(12) Patent Application Publication
(10) Pub. No.: US 2006/0069507 A1
(43) Pub. Date: Mar. 30, 2006

(54) Mobile device and method for controlling the same

(76) Inventor: Wataru Kokubo, Tokyo (JP)

Correspondence Address: FROMMER LAWRENCE & HAUG, 745 FIFTH AVENUE- 10TH FL., NEW YORK, NY, 10151, US

(21) Appl. No.: 11/224,869

(22) Filed: Sep. 13, 2005

(30) Foreign Application Priority Data
Sep. 15, 2004 (JP) 2004-268601

(51) Int. Cl. G08G 1/16

(52) U.S. Cl. 701/301

(57) ABSTRACT

A mobile device includes a mobile section having left and right independently and concurrently driven wheels. The mobile device can rotate about the axis thereof by spinning the wheels in directions opposite to each other. The mobile device further includes a sensor to detect an obstacle in front. The mobile device activates the sensor while rotating 360 degrees by spinning the left and right wheels in opposite directions and determines the presence of an obstacle in the vicinity. The mobile device then determines an area determined as an area containing no obstacle to be an area where the mobile device is able to freely move around.

### CROSS REFERENCES TO RELATED APPLICATIONS

The present invention contains subject matter related to Japanese-Patent Application JP 2004-268601 filed in the Japanese Patent Office on Sep. 15, 2004, the entire contents of which are incorporated herein by reference.

### BACKGROUND OF THE INVENTION

1. Field of the Invention

The present invention relates to a mobile device, such as a legged robot or a wheeled robot, including mobile means and to a method for controlling the mobile device and, in particular, to a mobile device that autonomously moves using mobile means and to a method for controlling the mobile device.

More specifically, the present invention relates to a mobile device that detects an obstacle and autonomously moves or carries out other tasks while avoiding a collision with the obstacle and a method for controlling the mobile device and, in particular, to a mobile device that reliably detects an obstacle and efficiently-avoids a collision with the obstacle and a method for controlling the mobile device.

2. Description of the Related Art

A machine that performs human-like movement electrically or magnetically is referred to as a “robot”. The term “robot” is derived from the Slavic word “ROBOTA (slave machine)”. In Japan, robots became popular at the end of the 1960s. A vast majority of them were industrial robots such as manipulators and transfer robots aimed at automation or unmanned operations in manufacturing in factories.

For example, robots including mobile means, such as wheels and movable legs, can coexist with human beings in a living environment and can autonomously move or carry out other tasks.

Wheeled robots have an advantage in terms of their moving speed and efficiency. Examples of wheeled mobile robots include: a six-wheeled vehicle for hazardous environments, which operates at disaster sites (refer to, for example, N. Kimura, T. Kamigaki, N. Suzuki, A. Nishikawa and N. Yamamoto, “Locomotion Mechanism and Control Architecture for Disaster Preventing Robot”, 1991 International Symposium on Advanced Robot Technology ('91 ISART), pp. 375-380, 1991); and a leg-wheel mobile device (refer to H. Adachi, N. Koyachi, T. Arai, A. Shimizu and Y. Nogami, “Mechanism and Control of a Leg-Wheel Hybrid Mobile Robot”, International Conference on Intelligent Robots and Systems Proc., pp. 1792-1797, 1999). Since a crawler uses continuous caterpillar tracks, a crawler can be considered a wheel in the broad sense of the term. Therefore, COMET-III, which was developed for removing mines, is also included in the examples (refer to, for example, URL: http://mec2.tm.chiba-u.jp/˜nonami/).

In contrast, legged mobile robots have high terrain adaptability and can carry out a flexible moving operation, and so legged mobile robots are adaptable to uneven grounds, walking surfaces having some obstacles, and uneven walking surfaces requiring climbing up and down, such as stairs and ladders. Recently, research and development of legged mobile robots, which are robots simulating the body mechanism and motions of biped animals such as human beings and monkeys, has made progress and expectations of the practical applications are growing (refer to, for example, Japanese Unexamined Patent Application Publication No. 13-129775).

To autonomously operate while coexisting with human beings, mobile robot devices may detect a variety of obstacles distributed in a living environment of the human beings and may move and carry out other tasks while avoiding a collision with the obstacles.

In general, to avoid a collision with the obstacles, obstacle detection means (e.g., an ultrasonic sensor or an infrared sensor) is provided in an autonomous mobile device.

For example, an autonomous mobile device is proposed in which the autonomous mobile device moves to a destination while avoiding a collision with detected obstacles (refer to, for example, Japanese Unexamined Patent Application Publication No. 2002-202815). The autonomous mobile device includes a scanning sensor for detecting the position of an obstacle by scanning a horizontal plane in the moving direction of the autonomous mobile device and a non-scanning obstacle sensor for detecting an obstacle in a space different from the scanned plane. In typical conditions, the autonomous mobile device detects an obstacle based on the output of the scanning sensor. If the scanning sensor outputs an obstacle detection signal, the autonomous mobile device activates the non-scanning sensor. The autonomous mobile device then estimates the position of the obstacle or the area where the obstacle exists based on the outputs from the two sensors. Thus, the autonomous mobile device can control itself to move to the destination based on the obstacle detection signals.

However, most of the mobile robots that detect an obstacle and avoid a collision with the obstacle regard an area in the moving direction as an area for detecting an obstacle.

For example, a biped mobile robot can achieve a moving operation on foot by alternately switching the left leg and the right leg to be a supporting leg and a free leg. Basically, a hip joint, a knee joint, and an ankle joint of each of the left and right legs can freely rotate about the pitch axis thereof so that the biped mobile robot faces towards the moving direction. In this case, even if the obstacle detection area is only in the moving direction, a problem does not occur.

However, when a robot moves backwards, it is difficult to carry out the obstacle detection process while facing in the forward direction. Accordingly, the robot may turn around 180 degrees to change the moving direction so that the moving direction aligns with that direction to detect an obstacle.

Recently, a robot device has been proposed in which the robot device realizes a motion in which every part of the body cooperates in a variety of forms, such as a dance (refer to, for example, Japanese Unexamined Patent Application Publication No. 2004-181613). In this case, since all directions are switched to the moving direction, the robot device needs to recognize an obstacle in 360 degrees around the robot device. However, in a system that detects an obstacle only in a single direction, it is highly likely that the system will not be able to acquire sufficient information to avoid a collision with the obstacle.

### SUMMARY OF THE INVENTION

According to an embodiment of the present invention, there is provided a superior mobile device and a method for controlling the mobile device, such as a legged robot and a wheeled robot, having a mobile section and capable of carrying out an autonomous moving operation.

According to an embodiment of the present invention, there is further provided a superior mobile device capable of moving while detecting an obstacle and avoiding a collision with the obstacle and capable of carrying out other autonomous operations, and a method for controlling the mobile device.

According to an embodiment of the present invention, there is still further provided a superior mobile device capable of reliably detecting an obstacle and efficiently avoiding a collision with the obstacle and a method for controlling the mobile device.

According to an embodiment of the present invention, the mobile device includes mobile means for carrying out a moving operation including forward and backward movements, obstacle detecting means for detecting an obstacle in the vicinity of the mobile device, control means for controlling the moving operation of the mobile means by determining an area determined as an area containing no obstacle to be a free area where the mobile device is able to freely move around.

In the mobile device, the mobile means may include a plurality of moving legs and wheels, for example, left and right wheels driven independently and concurrently. In this case, the mobile means can move straight ahead by spinning the left and right wheels at the same speed, the mobile means can turn left and right by spinning the left and right wheels at different speeds, and the mobile means can rotate about the axis thereof by spinning the left and right wheels in directions opposite to each other.

The mobile device may include a sensor, for example, an ultrasonic sensor or an infrared sensor to detect an obstacle in front. The obstacle detecting means can activate the sensor to determine the presence of an obstacle in the vicinity while rotating about the axis thereof by the operation of the mobile section.

Of course, the mobile device may include a plurality of sensors to detect an obstacle in all directions. However, in this case, the cost increases as the number of sensors increases. In contrast, if the mobile device detects an obstacle by using the rotational operation about the axis thereof, only one sensor is sufficient to detect an obstacle ahead of the mobile device.

According to an embodiment of the present invention, a mobile device determines an area determined as an area containing no obstacle to be a free area where the mobile device can freely move around. Thereafter, in the acquired free area, the mobile device freely moves around and carries out a predetermined operation without activating the obstacle detecting means. That is, once the mobile device acquires a free area, the mobile device can freely move in all directions without using a sensor for detecting an obstacle.

The obstacle detecting means can move to a position to detect an obstacle in the vicinity while rotating about the axis thereof and can recognize an obstacle in the vicinity at each position. The control section may keep track of an obstacle detected at each position using map information.

As described above, the present invention can provide a superior mobile device and a method for controlling the mobile device, such as a legged robot and a wheeled robot, having mobile means and capable of carrying out an autonomous moving operation.

The present invention can further provide a superior mobile device capable of moving while detecting an obstacle and avoiding a collision with the obstacle and capable of carrying out other autonomous operations, and a method for controlling the mobile device.

The present invention still further can provide a superior mobile device capable of reliably detecting an obstacle and efficiently avoiding a collision with the obstacle and a method for controlling the mobile device.

According to an embodiment of the present invention, a robot device includes mobile means composed of left and right wheels driven independently and concurrently. The robot device can rotate about the axis thereof by spinning the left and right wheels in directions opposite to each other. Additionally, the robot device includes a sensor to detect an obstacle in front. The robot device activates the sensor to determine the presence of an obstacle in the vicinity while rotating 360 degrees about the axis thereof by spinning the left and right wheels in opposite directions. The robot device then determines an area determined as an area containing no obstacle to be an area where the robot device 100 can freely move around.

In particular, the obstacle-avoidance operation based on obstacle detection by the mobile device according to an embodiment of the present invention is effective when detection of an obstacle 360 degrees in the vicinity is required. For example, a dance requires the detection of an obstacle in a 360-degree area around the robot devices so that the robot device can frequently move or rotate in all directions.

According to an embodiment of the present invention, a mobile device recognizes an area containing no obstacle in advance. Accordingly, once the mobile device recognizes the area, the obstacle detecting operation is not required every time the mobile device moves or rotates in all directions. As a result, the mobile device can smoothly carry out a predetermined operation, such as a movement operation.

Further features of the present invention will become apparent from the following description of exemplary embodiments with reference to the attached drawings.

### BRIEF DESCRIPTION OF THE DRAWINGS

FIG. 1 schematically illustrates the functional structure of a robot device 100 according to an embodiment of the present invention;

FIG. 2 schematically illustrates the structure of an independently-driven wheel mobile section;

FIGS. 3A and 3B illustrate a state in which the robot device attempts to detect an obstacle by rotating about the axis thereof and a state in which the robot device attempts to avoid a collision with an obstacle based on the detection result of the obstacle, respectively; and

FIG. 4 illustrates a flow chart of the operation to avoid a collision with an obstacle based on the detection result of the obstacle.

### DESCRIPTION OF THE PREFERRED EMBODIMENTS

Embodiments of the present invention are described in detail below with reference to the accompanying drawings.

The present invention relates to a robot device having a mobile section and capable of carrying out an autonomous moving operation. As used herein, for example, the mobile section can be composed of a plurality of movable legs and wheels. In this embodiment, a robot device having an independently-driven wheel mobile section, which includes left and right wheels driven independently and concurrently, is described as an example. Obviously, the present invention can be applied to a legged mobile robot in the same manner.

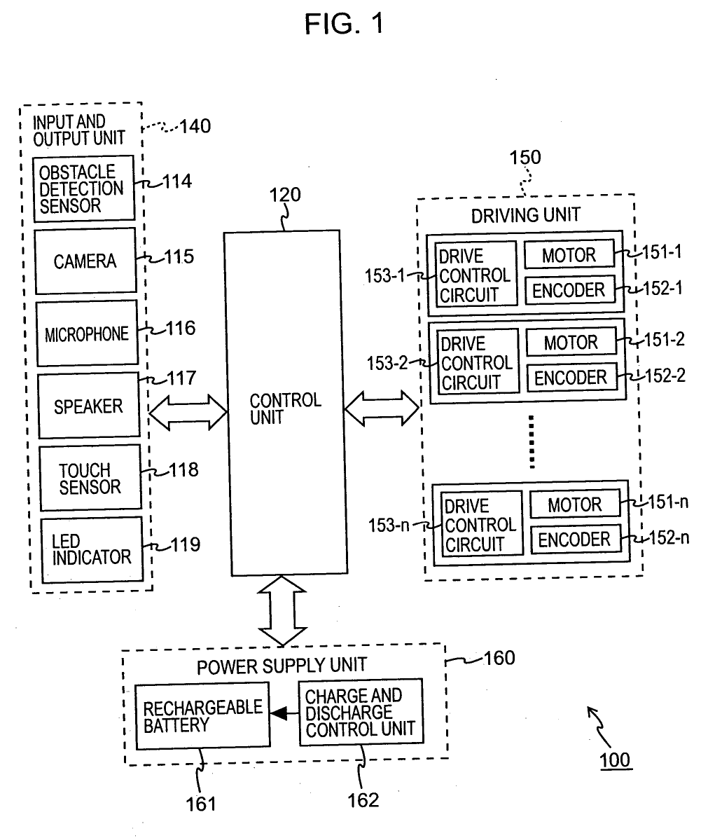

FIG. 1 schematically illustrates the functional structure of a robot device 100 according to an embodiment of the present invention. As shown in FIG. 1, the robot device 100 includes a control unit 120 for carrying out total control of the whole operation and other data processing, an input and output unit 140, a driving unit 150, and a power supply unit 160. Each unit is described next.

The input and output unit 140 includes a charge coupled device (CCD) camera 115, which functions as an input unit to detect an external environment and corresponds to the eyes of the robot device 100; a microphone 116 corresponding to ears; and either a touch sensor 118 corresponding to the haptic sense or a variety of other sensors corresponding to the five senses. To provide feedback to a user, the input and output unit 140 further includes the following output unit: a speaker 117 corresponding to a mouth or LED indicators 119 which represent the facial expression by a combination of emitting light and by the timing of the emitted light. Therefore, the output units can achieve feedback to a user from the robot device 100 in a form other than a mechanical motion pattern of the four limbs.

Since the robot device 100 includes the camera 115, the robot device 100 can recognize the shape and color of any object present in a work space, and can further recognize an obstacle. In addition to the visual mechanism like a camera, the robot device 100 may include an obstacle detection sensor 114 which receives transmission waves, such as infrared light, sound waves, ultrasonic waves, and radio waves. In this case, the robot device 100 can recognize an obstacle in the moving direction of the transmission waves by measuring a position and direction of a transmission source based on the output of the sensor detecting the transmission waves.

The driving unit 150 is a functional block for realizing a mechanical motion of the robot device 100 in accordance with a predetermined motion pattern instructed by the control unit 120. For example, the driving unit 150 is composed of a drive unit mounted on each of the independent drive wheels. Alternatively, for a legged mobile robot device, the driving unit 150 is composed of drive units mounted on a head joint, a hip joint, and a knee joint for each of the roll, pitch, and yaw rotation axes of each joint. In the example shown in FIG. 1, the robot device 100 has n number of degrees of joint freedom. Accordingly, the driving unit 150 includes n number of drive units. Each drive unit includes a motor 151 which rotates about a predetermined axis, an encoder 152 for detecting the rotational position of the motor 151, and a drive control circuit 153 for adaptively controlling the rotational position and the rotation speed of the motor 151 based on the output of the encoder 152.

The power supply unit 160 is a functional module for supplying power to a variety of circuits in the robot device 100. The robot device 100 according to this embodiment autonomously operates using a battery. The power supply unit 160 includes a rechargeable battery 161 and a charge and discharge control unit 162 for controlling a charge and discharge level of the rechargeable battery 161.

The rechargeable battery 161, for example, includes a “battery pack” in which a plurality of nickel-cadmium battery cells are packaged in a cartridge format.

Additionally, the charge and discharge control unit 162 detects the amount of charge remaining in the rechargeable battery 161 by measuring the terminal voltage and charge/discharge electrical current of the rechargeable battery 161, and the temperature around the rechargeable battery 161 so as to determine the start time and end time of charging. The start time and end time of charging determined by the charge and discharge control unit 162 are sent to the control unit 120 and trigger the start and end of the charging operation of the robot device 100.

The control unit 120 corresponds to a “brain”. For example, the control unit 120 is incorporated in a head portion or a body portion of the robot device 100.

As stated above, the robot device 100 according to the embodiment of the present invention includes the independently-driven wheel mobile section, which has the left and right wheels driven independently and concurrently. In this design, the robot device 100 moves straight ahead by spinning the left and right wheels at the same speed. The robot device 100 turns left or right by spinning the left and right wheels at different speeds. Also, the robot device 100 can rotate about the axis thereof by spinning the left and right wheels in directions opposite to each other.

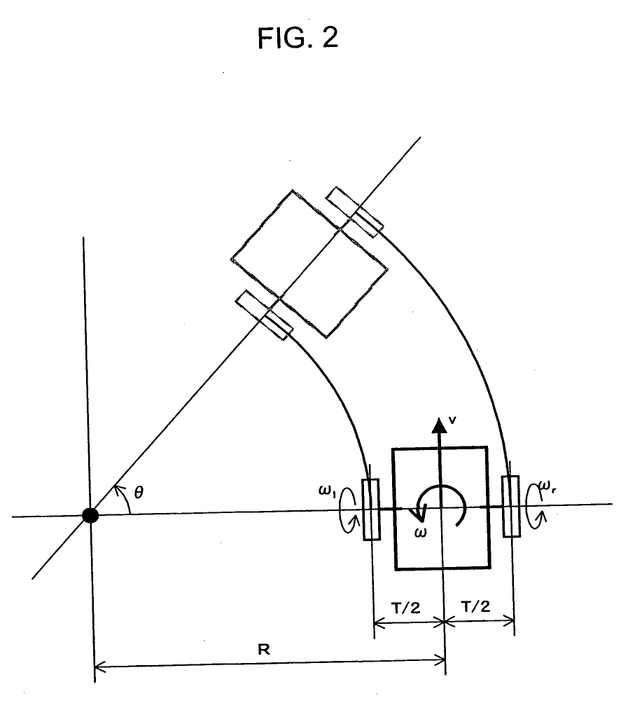

FIG. 2, schematically illustrates the structure of the independently-driven wheel mobile section. The turning radius is described below with reference to FIG. 2 when the robot device 100 turns left or right.

Different rotation speeds are given to the left and right wheels. Thus, a speed v in the moving direction and an angular velocity ωof turning the robot device 100 can be obtained. The turning radius or the radius of curvature can be derived from these speeds as follows:

$$v = \frac{{R}_{W}}{2} ( {ω}_{r} + {ω}_{i} )$$

$$ω = \frac{{R}_{W}}{T} ( {ω}_{r} - {ω}_{i} )$$

where the angular velocities of the left and right wheels are ωₗ and ωᵣ, respectively, the distance between the left and right driving wheels is T, and the radius of the driving wheel is R_{w}.

The steering mechanism using independently driven wheels is described in more detail by, for example, K. YONEDA et al., “Introduction to robot creative design”, Kodansha, Sep. 20, 2001, p. 15 (In Japanese).

As stated above, by making the right and left wheels rotate in opposite directions each other, the robot device 100 can rotate about the axis thereof. The robot device 100 includes the obstacle detection sensor 114 composed of an ultrasonic sensor or an infrared sensor to detect an obstacle ahead. When rotating about the axis thereof, the robot device 100 can activate the obstacle detection sensor 114 to determine the presence of an obstacle in 360 degrees around the robot device 100.

Of course, the robot device 100 may include a plurality of sensors in order to detect an obstacle in all directions. However, the cost increases as the number of sensors increases. In contrast, if the robot device 100 detects an obstacle by using the rotational operation about the axis thereof, only one sensor is sufficient to detect an obstacle ahead of the robot device 100.

The control unit 120 determines the presence of an obstacle in 360 degrees around the current position based on the output of the obstacle detection sensor 114. The control unit 120 then determines an area determined as an area containing no obstacle to be an area where the robot device 100 can freely move around. Thereafter, the control unit 120 controls a moving operation based on the positional information obtained in this manner.

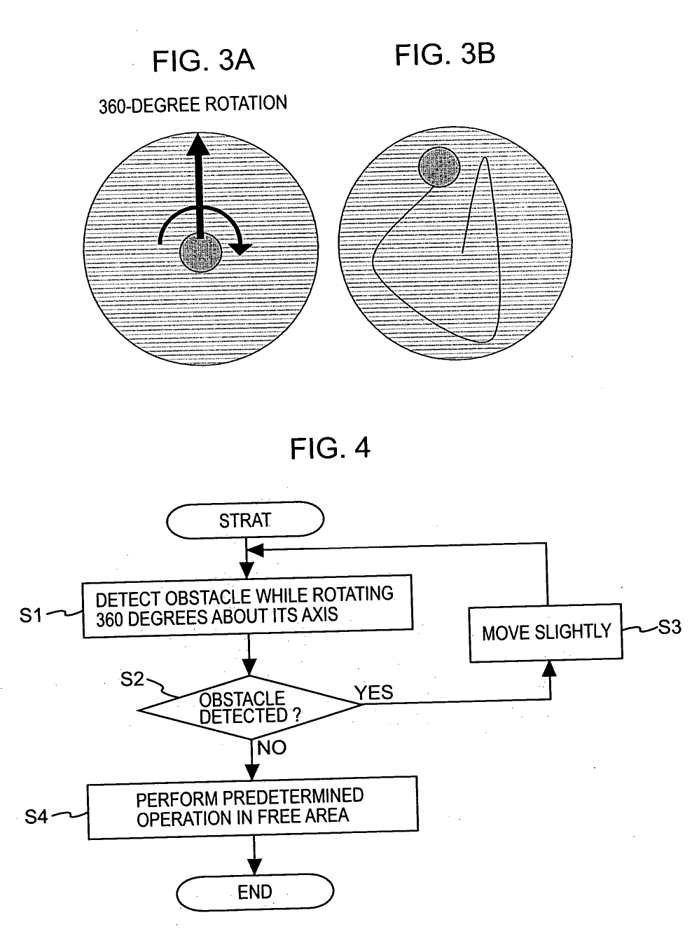

FIGS. 3A and 3B illustrate a state in which the robot device attempts to detect an obstacle by rotating about the axis thereof and a state in which the robot device attempts to avoid a collision with an obstacle based on the detection result of the obstacle, respectively. In an example of FIG. 3B, the robot device can freely move around a free area without the need for detecting an obstacle.

FIG. 4 illustrates a flow chart of the operation to avoid a collision with an obstacle based on the detection result of the obstacle.

First, the robot device 100 rotates about the axis thereof by driving the mobile section (e.g., independent drive wheels). The robot device 100 detects an obstacle based on the output of the obstacle detection sensor 114 during one rotation (step S1).

If the robot device 100 detects an obstacle (step S2), the robot device 100 slightly moves from the current position (step S3). For example, the robot device 100 moves by several centimeters to several tens of centimeters. Thereafter, the process returns to step S1, where the robot device 100 detects an obstacle again at the new position.

These obstacle detecting operation and moving operation are repeatedly carried out until the robot device 100 is unable to detect an obstacle. Subsequently, the robot device 100 determines an area where no obstacle is found as a free area. The robot device 100 then starts a predetermined operation (e.g., a dance) (step S4). In this free area, the robot device 100 can freely move in all directions without using a sensor for detecting an obstacle.

In a loop formed by steps S1 to S3 of the above-described flow chart, when the robot device 100 rotates about the axis thereof and moves to a new position for detecting an obstacle and when the robot device 100 recognizes an obstacle at each position, the robot device 100 may keep track of the obstacle detected at each position as map information.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile device comprising:
mobile means for carrying out a moving operation;
obstacle detecting means for detecting an obstacle in the vicinity of the mobile device; and
control means for controlling the moving operation of the mobile means by determining an area determined as an area containing no obstacle to be a free area where the mobile device is able to freely move around.

2. The mobile device according to claim 1, wherein the mobile means comprises left and right wheels driven independently and concurrently and wherein the mobile means moves straight ahead by spinning the left and right wheels at the same speed, the mobile means turns left and right by spinning the left and right wheels at different speeds, and the mobile means rotates about the axis thereof by spinning the left and right wheels in directions opposite to each other.

3. The mobile device according to claim 1, further comprising:
a sensor that detects an obstacle in front;
wherein the obstacle detecting means activates the sensor to determine the presence of an obstacle in the vicinity while rotating about the axis thereof by the operation of the mobile means.

4. The mobile device according to claim 1, wherein the control means makes the mobile means carry out a predetermined moving operation in a free area acquired based on an obstacle detecting process carried out by the obstacle detecting means without activating the obstacle detecting means.

5. The mobile device according to claim 3, wherein the obstacle detecting means moves to a position to detect an obstacle in the vicinity while rotating about the axis thereof and wherein the control means keeps track of an obstacle detected at a different position using map information.

6. A method for controlling a mobile device including mobile means, comprising the steps of:
detecting an obstacle in the vicinity of the mobile device; and
controlling a moving operation of the mobile means by determining an area determined as an area containing no obstacle to be a free area where the mobile device is able to freely move around.

7. The method for controlling a mobile device according to claim 6, wherein the mobile means comprises left and right wheels driven independently and concurrently and wherein the mobile means moves straight ahead by spinning the left and right wheels at the same speed, the mobile means turns left and right by spinning the left and right wheels at different speeds, and the mobile means rotates about the axis thereof by spinning the left and right wheels in directions opposite to each other.

8. The method for controlling a mobile device according to claim 6, wherein the mobile means further comprises a sensor that detects an obstacle in front and wherein the sensor is activated at the step of detecting an obstacle to determine the presence of an obstacle in the vicinity of the mobile device while rotating about the axis of the mobile device by the operation of the mobile means.

9. The method for controlling a mobile device according to claim 6, wherein a predetermined moving operation of the mobile means is carried out in a free area previously acquired based on an obstacle detecting process at the step of detecting an obstacle without activating the process at the step of detecting an obstacle.

10. The method for controlling a mobile device according to claim 8, wherein a position to detect an obstacle in the vicinity of the mobile device while rotating about the axis of the mobile device is moved at the step of detecting an obstacle and wherein an obstacle detected at a different position is kept track of as map information at the step of controlling the moving operation.

11. A mobile device comprising:
a mobile section configured to carry out a moving operation;
an obstacle detecting section configured to detect an obstacle in the vicinity of the mobile device; and
a control section configured to control the moving operation of the mobile section by determining an area determined as an area containing no obstacle to be a free area where the mobile device is able to freely move around.

12. A method of controlling a mobile device including a mobile section, comprising the steps of:
detecting an obstacle in the vicinity of the mobile device; and
controlling a moving operation of the mobile section by determining an area determined as an area containing no obstacle to be a free area where the mobile device is able to freely move around.
